(19) United States
(12) Patent Application Publication
(10) Pub. No.: US 2002/0130188 A1
(43) Pub. Date: Sep. 19, 2002

(54) Identification label for coding media in strip or tape form wound onto hubs

(75) Inventor: Bernd Scholtysik, Muenchen (DE)

Correspondence Address: GREENBLUM & BERNSTEIN, P.L.C., 1941 ROLAND CLARKE PLACE, RESTON, VA, 20191, US

(73) Assignee: EMTEC MAGNETICS GmbH, Ludwigshafen (DE)

(21) Appl. No.: 10/096,869

(22) Filed: Mar. 14, 2002

(30) Foreign Application Priority Data
Mar. 15, 2001 (DE) 201 04 430.7

(51) Int. Cl. G06K 19/06

(52) U.S. Cl. 235/494

(57) ABSTRACT

Identification label for coding media in strip or tape form that is wound onto a hub. The label includes information indicating at least a product designation, at least a production code, and at least a quality class or classification, as well as information indicating a position of at least one defect of the media.

### CROSS-REFERENCE TO RELATED APPLICATIONS

The present application claims priority under 35 U.S.C. §119 of German Patent Application No. 201 04 430.7, filed on Mar. 15, 2001, the disclosure of which is expressly incorporated by reference herein in its entirety.

### BACKGROUND OF THE INVENTION

1. Field of the Invention

The invention relates to an identification label for coding media in strip or tape form, and in particular to an identification label for coding magnetic data recording media in tape form that is wound onto hubs.

2. Discussion of Background Information

FIG. 1 shows a prior art pancake 1 of media in strip or tape form which has been slit to a usable width. The magnetic data recording media 3 is wound onto hubs 2 for further processing. These so-called pancakes 1 are formed of media in strip or tape form and measure several thousand meters in length. Each pancake 1 uses a sealing adhesive strip 4 and an identification label 5.

Both the sealing adhesive strip 4 and the identification label 5 are attached on the outermost layer 3.1 of the pancake 1 by adhesion. The sealing adhesive strip 4 fixes the free end 3.2 of the magnetic data recording medium 3 on the outermost layer 3.1 of the pancake 1, which consequently seals the pancake 1. Both the width of the sealing adhesive strip 4 and the width of the identification label 5 generally correspond to the usable width of the magnetic data recording medium. This width can be, for example, ½″ in the case of the VHS system.

FIG. 2 shows a prior art identification label 5. The label 5 generally includes a product designation 5.1, a production code 5.2, and, depending on the manufacturer, a quality classification 5.3 specific to the pancake 1. These data designations are typically printed onto the identification label 5 as plain text and/or as a barcode.

The quality classification 5.3 is derived and/or based essentially on continuous sensing of image-impairing defects of the magnetic data recording medium in tape form. These defects are usually so-called dropouts. The defects are sensed by means of sensors during a slitting operation which produces individual tapes from a semifinished product. These individual tapes will be made to have a usable width and will be assigned at least one sensor. It should be noted at this point that the term semifinished product is to be understood as meaning a base material in the form of a film coated with a magnetic dispersion, both the width and length of which are many times the width and length of the magnetic data recording medium that is wound up to form a pancake 1, i.e., the semifinished product is usually a web whose width is many times the width of the individual tapes and when this web is slit longitudinally, it forms many individual tapes of desired width.

The positions of the image-impairing defects sensed by a sensor along the length of the tape are stored in a computer and can be called up and printed out at the end of each slitting operation.

Depending on the number of defects sensed by a sensor, different quality classifications are assigned for the pancakes 1. Thus, a pancake 1 having just a few defects is designated as “B grade.” Such “B grade” pancakes are typically supplied to the retail trade. However, one disadvantage of the prior art labels the identification label 5 provides information only on the quality classification of the pancake 1. There is no indication on the label with regard to the position of the image-impairing defects detected by a sensor. Because the prior art label lacks such information, further processing of the pancake is required to determine the position of the defects. Consequently, the regions affected by defects must, first of all, be re-located by means of suitable testing devices, and then excluded from further processing.

### SUMMARY OF THE INVENTION

The present invention provides an identification label which overcomes the disadvantages of the prior art and makes it possible for the position of the image-impairing defects detected by a sensor to be easily located and/or known.

Accordingly, the invention therefore provides for an identification label for coding media in strip or tape form, in particular magnetic data recording media in tape form, that is wound up on hubs, and which notes the position of the defects of the medium in strip or tape form sensed by a sensor. This information is noted in addition to the information specifying the product designation, production code and quality class.

The invention also provides for an identification label for coding media in strip or tape form that is wound onto a hub, the label including information specifying at least a product designation, at least a production code, and at least a quality class or classification, and information specifying a position of at least one defect of the media.

The position of any defects of the media strip may correspond to a position that was sensed by a sensor. The media in strip or tape form may be magnetic data recording media. The media in strip or tape form that is wound onto a hub may comprise a pancake. The information specifying a position of at least one defect of the media may comprise information specifying various position of various defects. The information specifying a position of at least one defect of the media may comprise a representation of a length of the wound media. The information specifying at least a product designation, at least a production code, and at least a quality class or classification may comprise printed information. The information specifying a position of at least one defect of the media may comprise printed information. Each of the information specifying at least a product designation, at least a production code, and at least a quality class or classification and the information specifying a position of at least one defect of the media may comprise printed information. The information specifying a position of at least one defect of the media may comprise a scalar strip. The scalar strip may comprise a series of square or rectangular marking fields. The information specifying a position of at least one defect of the media may comprise a scaling. The information specifying a position of at least one defect of the media may comprise a scalar strip having marking fields and a scaling, each marking field defining a region of a length of the wound media. The position of a defect may correspond to at least one of a mark and a symbol that is located in a marking field. The position of a defect may correspond to at least one of a mark and a symbol that is printed on the label. The information specifying a position of at least one defect of the media may comprise a graphic representation. The graphic representation may indicate a length of the wound media. The graphic representation may comprise a scalar strip in the form of one of a dashed line and a series of dashes. The graphic representation may further comprise a scaling. Each individual graduation of the scaling may define a region of a length of the wound media. The graphic representation may further comprise at least one symbol or marking, whereby the position of a defect is identifiable by comparing the symbol or marking with the scaling.

The invention also provides for an identification label for coding wound media, the label including information indicating at least one of a product designation, a production code, and a quality class or classification, and information indicating a position range or location range of at least one defect of the wound media.

The wound media may be in strip or tape form. The wound media may comprise a pancake. The information indicating a position of at least one defect of the media may comprise information indicating various positions of various defects. The information indicating a position of at least one defect of the media may comprise a representation of a length of the wound media. The information indicating at least one of a product designation, a production code, and a quality class or classification may comprise printed information. The information indicating a position of at least one defect of the wound media may comprise printed information. Each of the information indicating at least a one of a product designation, a production code, and a quality class or classification and the information indicating a position of at least one defect of the wound media may comprise printed information. The information indicating a position of at least one defect of the wound media may comprise a scalar strip. The scalar strip may comprise a series of square or rectangular marking fields. The information indicating a position of at least one defect of the media may comprise a scaling. The information indicating a position of at least one defect of the wound media may comprise a scalar strip having marking fields and a scaling, each marking field defining a region of a length of the wound media. The position of a defect may correspond to at least one of a mark and a symbol that is located in a marking field. The position of a defect may correspond to at least one of a mark and a symbol that is printed on the label. The information indicating a position of at least one defect of the wound media may comprise a graphic representation. The graphic representation may indicate a length of the wound media. The graphic representation may comprise a scalar strip in the form of one of a dashed line and a series of dashes. The graphic representation may further comprise a scaling. Each individual graduation of the scaling may define a region of a length of the wound media. The graphic representation may further comprise at least one symbol or marking, whereby the position of a defect is identifiable by comparing the symbol or marking with the scaling.

The invention also provides for the combination of a pancake of wound media and an identification label for coding wound media, wherein the label includes information indicating at least one of a product designation, a production code, and a quality class or classification, and information indicating a position range or location range of at least one defect of the wound media.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a prior art pancake of a magnetic data recording medium in tape form;

FIG. 2 shows a prior art identification label;

FIG. 3a shows a first embodiment of an identification label according to the invention;

FIGS. 3b-d show identification labels corresponding to FIG. 3a, but with different information specifying the position of the defects sensed by a sensor; and

FIG. 4 shows a second embodiment of an identification label according to the invention.

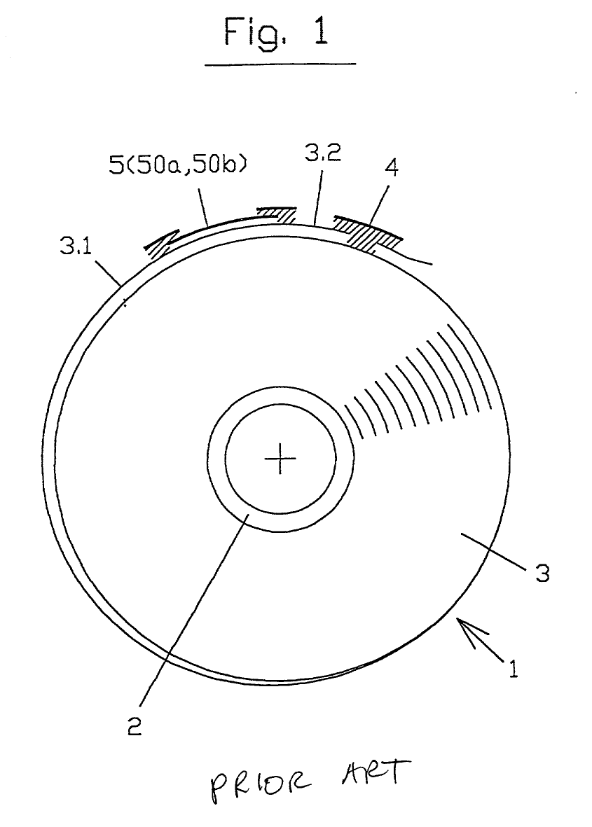

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

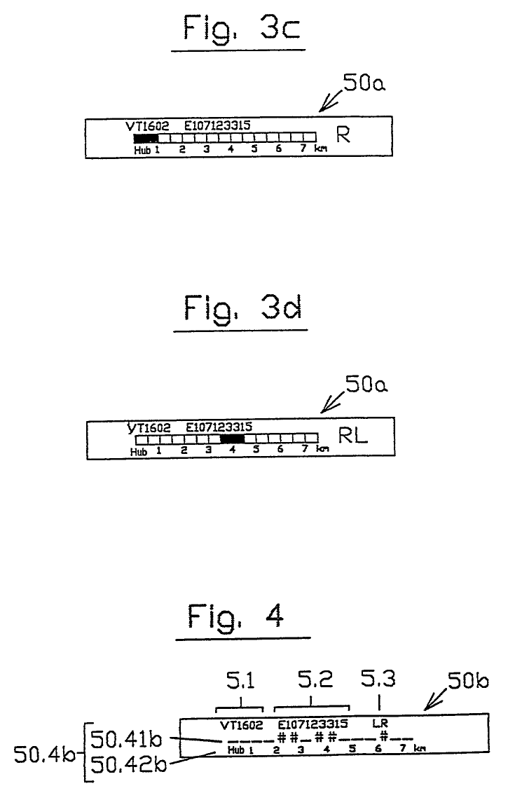

FIG. 3a illustrates a first embodiment of an identification label 50a according to the invention. The label 50a includes a coding 50.4a which indicates the position of the defects sensed by a sensor. The first line of text on the label 50a indicates the product designation 5.1 and the production code 5.2. These codes are printed on the label 50a. The second line contains a graphic representation 50.4a which are indicative of the length of the pancake 1 (i.e., the length of tape wound onto the pancake 1). The graphic representation includes a scalar strip portion 50.41a and an associated scaling 50.42a that identifies the position of the defects sensed by a sensor. In the edge region of the identification label 50a, there is provided the coding or information relating to quality classification 5.3 (here designated as “L”).

In this embodiment, the graphic representation 50.4a of the length of the pancake 1 includes a scalar strip 50.41a which is formed by a series of square or rectangular marking fields 50.410a. Each marking field 50.410a defines a region along the length of the pancake 1. The scaling 50.42a is provided below the scalar strip 50.41a. The scaling 50.42a has a beginning portion which is located under the first marking field and is designated by the word “Hub” (corresponding to the beginning of the tape that is wound on the hub). The scaling 50.42a continues as a series of numbers which specify the length of the wound-up magnetic data recording medium 3. The scaling 50.42a ends with an indication of the unit of length (i.e., indicating the total length of the tape). In the embodiment shown in FIG. 3a, each marking field 50.410a defines a region of approximately 500 m (0.5 km) in length. Consequently, the series of numbers of the scaling 50.42a under the second marking field (i.e., the second rectangle) begins with the number “1” and continues in such a way that there is a number under every alternate marking field. As can be seen, these numbers increase by the value “1” with respect to the previous number.

This arrangement makes it possible to mark sensed defects within 500 m (0.5 km) regions. The coding 50.411a of the particular position of the defects sensed by a sensor is accomplished by marking the corresponding square or rectangular marking field, e.g., in this case rectangle 50.410a. This marking may take place, for example, by blackening the corresponding marking field (as is shown). Alternatively, a marking or symbol of any desired type may be provide in the marking field.

In principle, the representation of the scalar strip 50.41a and of the scaling 50.42a may also be made to apply to regions of more or less than approximately 500 m, with the lower limit of the region being determined by the legibility or by the assignment and number of items of information per region.

As can be seen in FIG. 3a, the particular identification label 50a illustrated characterizes a pancake 1 whose length is approximately 7500 m (7.5 km) and which has defects, sensed by a sensor, in the region between 5000 m and 5500 m (5 and 5.5 km). As is also evident from FIG. 3a, the imprint of the product designation 5.1 and of the production code 5.2 are only given in plain text, i.e., there is no additional bar code. This is because this label is designed to be used with “B grade” pancakes, which do not generally require further processing in the manufacturer's internal production area. As a result, it is possible to dispense with the barcode imprint on such pancakes. However, it should be noted that the invention contemplates labels which use such bar codes and/or which use additional other information, when desired.

The identification label 50a represented in FIG. 3b is similar to that shown in FIG. 3a except that it characterizes a pancake 1 of approximately 7500 m (7.5 km) in length with defects, sensed by a sensor, being located in the region from 6000 m to 7000 m (6 to 7 km). Note that the two blackened regions are located between 6 and 7 km. In the edge region of the identification label 50a, there is provided the coding or information relating to quality classification (here designated as “R”).

The identification label 50a represented in FIG. 3c is similar to that shown in FIG. 3a except that it characterizes a pancake 1 of approximately 7500 m (7.5 km) in length with defects, sensed by a sensor, being located in the region between the Hub and 1000 m (1 km). Note that the two blackened regions are located between Hub and 1 km. In the edge region of the identification label 50a, there is provided the coding or information relating to quality classification (here designated as “R”).

The identification label 50a represented in FIG. 3d is similar to that shown in FIG. 3a except that it characterizes a pancake 1 of approximately 7500 m (7.5 km) in length with defects, sensed by a sensor, being located in the region between 3500 m and 4500 m (3.5 and 4.5 km). Note that the two blackened regions are located between 3.5 and 4.5 km. In the edge region of the identification label 50a, there is provided the coding or information relating to quality classification (here designated as “RL”).

FIG. 4 shows another embodiment of an identification label 50b according to the invention. This label 50b substantially corresponds to the label previously described with regard to the product designation 5.1 and production code 5.2. However, in this label 50b, the quality classification 5.3 is provided in the first line of the label 50b (here designated as “LR”).

With regard to the graphic representation 50.4b of the length of the pancake 1 the label 50b differs from that previously described. As can be seen from FIG. 4, the second line of the identification label 50b includes simple symbols. These symbols are selected of a kind which can be efficiently applied to the identification label 50b by way of needle or thermal transfer printing. Of course, other printing techniques, whether conventional or otherwise, may also be utilized. In the example shown, the scalar strip 50.41b is stylized by a dashed line. Each individual graduation in turn corresponds to a defined region of length. The scaling 50.42b is provided in a way that is analogous to the scaling 50.42a of the previous embodiment. The position of a defect, sensed by a sensor, is indicated by a graduation which is assigned to a region of length affected by sensor-detected defects being substituted by any desired symbol(s), such as for example “#” (shown) or “X” (not shown). In other words, the substitution of one symbol for another can be used to indicate the position of the defects, or one common symbol can be used to designate all regions which have no defects, while another symbol or symbols can be used to designate a region with defects.

The identification label 50b represented in FIG. 4 consequently characterizes a pancake 1 of 7500 m (7.5 km) in length with defects, sensed by a sensor, in the region between 2000 m and 3000 m (2 and 3 km), and in the region between 3500 m and 4500 m (3.5 and 4.5 km), and also in the region between 6000 m and 6500 m (6 and 6.5 km).

Although not shown, the labels 50a described in FIGS. 3a-3d can also be coded to designate a number of defect regions in a manner similar to that shown in FIG. 4. Thus, for example, the label shown FIG. 3a can be used to designate defects, sensed by a sensor, that are located in the region between 3500 m and 4500 m (3.5 and 4.5 km), as is shown in FIG. 3a, and additionally coded in other regions, e.g., in the region between 1000 m and 2000 m (1 and 2 km), although this is not shown in FIG. 3a.

In the case of where the magnetic data recording media in tape form is of the type having a small width, e.g., a width that is smaller ½″, the information specifying the product designation 5.1, production code 5.2, quality classification 5.3, and the graphic representation 50.4a of the length of the pancake 1 can be arranged and/or provided in one line (i.e, a single line can be used in stead of two lines) on the identification label 50a or 50b (not shown).

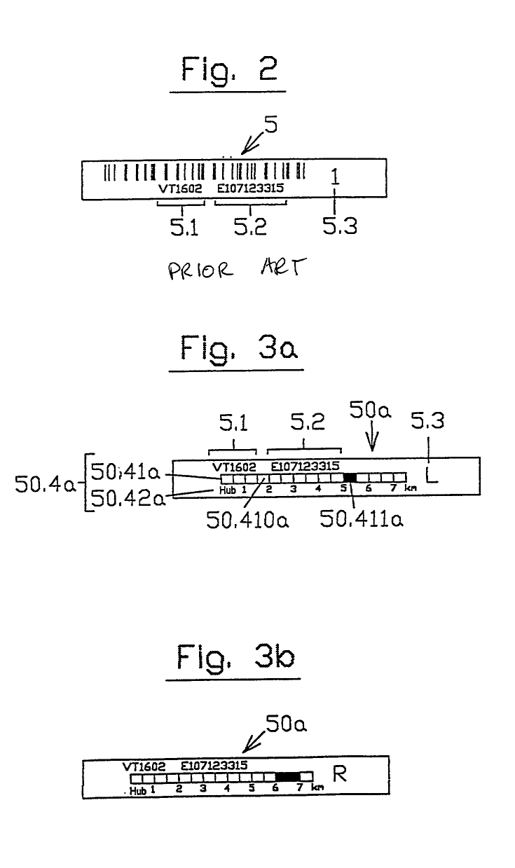

The quality classification 5.3 is generally encoded, with the quality classification “1” indicated in FIG. 2, for example, characterizing a pancake which is defect-free. On the other hand, the quality classifications “L”, “R” and “LR” are assigned to and/or designate different types of defects.

The identification label 50a and 50b of the invention may be made of paper or plastic film. However, the invention contemplates that the label may be made of any desired material, conventional or otherwise, provided it is possible for it to be fastened on the pancake 1 and/or on magnetic data recording medium 3 by way of adhesive strip. The invention also contemplates that the label may be of the self-adhesive type, i.e., a self-adhesive label.

The use of the identification label 50a and 50b according to the invention makes it possible, during the further processing of pancakes 1 that have regions affected by defects, to dispense with additional testing devices for re-determining and/or re-locating the defect-affected regions in the media, and also to cut out the identified region from the pancake 1.

In should be noted that the invention is not limited to pancakes that are made up of magnetic data recording media in tape form. It can also be practiced advantageously with any and/or all other media types, whether in strip or tape form and that are provided with functional layers.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An identification label for coding media in strip or tape form that is wound onto a hub, the label including:
information specifying at least a product designation, at least a production code, and at least a quality class or classification; and
information specifying a position of at least one defect of the media.

2. The identification label of claim 1, wherein the position of any defect of the media strip corresponds to a position that was sensed by a sensor.

3. The identification label of claim 1, wherein the media in strip or tape form is magnetic data recording media.

4. The identification label of claim 1, wherein the media in strip or tape form that is wound onto a hub comprises a pancake.

5. The identification label of claim 1, wherein information specifying a position of at least one defect of the media comprises information specifying various position of various defects.

6. The identification label of claim 1, wherein the information specifying a position of at least one defect of the media comprises a representation of a length of the wound media.

7. The identification label of claim 1, wherein the information specifying at least a product designation, at least a production code, and at least a quality class or classification comprises printed information.

8. The identification label of claim 1, wherein the information specifying a position of at least one defect of the media comprises printed information.

9. The identification label of claim 1, wherein each of the information specifying at least a product designation, at least a production code, and at least a quality class or classification and the information specifying a position of at least one defect of the media comprises printed information.

10. The identification label of claim 1, wherein the information specifying a position of at least one defect of the media comprises a scalar strip.

11. The identification label of claim 10, wherein the scalar strip comprises a series of square or rectangular marking fields.

12. The identification label of claim 10, wherein the information specifying a position of at least one defect of the media comprises a scaling.

13. The identification label of claim 1, wherein the information specifying a position of at least one defect of the media comprises a scalar strip having marking fields and a scaling, each marking field defining a region of a length of the wound media.

14. The identification label of claim 13, wherein the position of a defect corresponds to at least one of a mark and a symbol that is located in a marking field.

15. The identification label of claim 1, wherein the position of a defect corresponds to at least one of a mark and a symbol that is printed on the label.

16. The identification label of claim 1, wherein the information specifying a position of at least one defect of the media comprises a graphic representation.

17. The identification label of claim 1, wherein the graphic representation indicates a length of the wound media.

18. The identification label of claim 17, wherein the graphic representation comprises a scalar strip in the form of one of a dashed line and a series of dashes.

19. The identification label of claim 18, wherein the graphic representation further comprises a scaling.

20. The identification label of claim 19, wherein each individual graduation of the scaling defines a region of a length of the wound media.

21. The identification label of claim 18, wherein the graphic representation further comprises at least one symbol or marking, whereby the position of a defect is identifiable by comparing the symbol or marking with the scaling.

22. An identification label for coding wound media, the label including:
information indicating at least one of a product designation, a production code, and a quality class or classification; and
information indicating a position range or location range of at least one defect of the wound media.

23. The identification label of claim 22, wherein the wound media is in strip or tape form.

24. The identification label of claim 22, wherein the wound media comprises a pancake.

25. The identification label of claim 22, wherein information indicating a position of at least one defect of the media comprises information indicating various positions of various defects.

26. The identification label of claim 22, wherein the information indicating a position of at least one defect of the media comprises a representation of a length of the wound media.

27. The identification label of claim 22, wherein the information indicating at least one of a product designation, a production code, and a quality class or classification comprises printed information.

28. The identification label of claim 22, wherein the information indicating a position of at least one defect of the wound media comprises printed information.

29. The identification label of claim 22, wherein each of the information indicating at least a one of a product designation, a production code, and a quality class or classification and the information indicating a position of at least one defect of the wound media comprises printed information.

30. The identification label of claim 22, wherein the information indicating a position of at least one defect of the wound media comprises a scalar strip.

31. The identification label of claim 30, wherein the scalar strip comprises a series of square or rectangular marking fields.

32. The identification label of claim 30, wherein the information indicating a position of at least one defect of the media comprises a scaling.

33. The identification label of claim 22, wherein the information indicating a position of at least one defect of the wound media comprises a scalar strip having marking fields and a scaling, each marking field defining a region of a length of the wound media.

34. The identification label of claim 33, wherein the position of a defect corresponds to at least one of a mark and a symbol that is located in a marking field.

35. The identification label of claim 22, wherein the position of a defect corresponds to at least one of a mark and a symbol that is printed on the label.

36. The identification label of claim 22, wherein the information indicating a position of at least one defect of the wound media comprises a graphic representation.

37. The identification label of claim 22, wherein the graphic representation indicates a length of the wound media.

38. The identification label of claim 37, wherein the graphic representation comprises a scalar strip in the form of one of a dashed line and a series of dashes.

39. The identification label of claim 38, wherein the graphic representation further comprises a scaling.

40. The identification label of claim 39, wherein each individual graduation of the scaling defines a region of a length of the wound media.

41. The identification label of claim 38, wherein the graphic representation further comprises at least one symbol or marking, whereby the position of a defect is identifiable by comparing the symbol or marking with the scaling.

42. The combination of a pancake of wound media and an identification label for coding wound media, wherein the label includes:
information indicating at least one of a product designation, a production code, and a quality class or classification; and
information indicating a position range or location range of at least one defect of the wound media.
